(19) United States
(12) Patent Application Publication
(10) Pub. No.: US 2012/0221446 A1
(43) Pub. Date: Aug. 30, 2012

(54) E-RECEIPTS COLLECTION AND MANAGEMENT SYSTEM

(75) Inventors: David M. Grigg, Rock Hill, SC (US); Carrie Anne Hanson, Charlotte, NC (US); Cindy Kerber, Cornelius, NC (US); Elizabeth S. Votaw, Potomac, MD (US)

(73) Assignee: BANK OF AMERICA CORPORATION, Charlotte, NC (US)

(21) Appl. No.: 13/036,716

(22) Filed: Feb. 28, 2011

(51) Int. Cl. G06Q 99/00

(52) U.S. Cl. 705/30

(57) ABSTRACT

In general, embodiments of the present invention concern the collection and management of a consumer's detailed receipt information in electronic form and the storage of the electronic receipts in a platform accessible to the consumer online or through the consumer's mobile device.

### BACKGROUND

Consumers receive receipts after making purchases in a variety of ways. Sometimes a vendor may provide a consumer with a paper receipt. For in-store purchases, consumers generally obtain a paper receipt at the point-of-sale. For telephone or online purchases, consumers may wait for a paper receipt to arrive in the mail However, it is becoming more and more common for vendors to provide consumers with electronic receipts. Typically, consumers provide vendors with one or more email addresses and receive electronic receipts through their email accounts. Thus, for any given period of time, a consumer may have a plurality of paper receipts and a plurality of electronic receipts, which may be stored in various email accounts.

Regardless of whether consumers' receipts are all paper, electronic or a mix of both, consumers need to save their receipts after making a purchase for a variety of reasons. Saved receipts may be used by consumers to return merchandise, to track expenses for budgeting purposes, or to substantiate tax, reimbursement, or warranty claims, among many other uses. Currently, consumers collect paper receipts and save and organize them in physical space. Similarly, consumers collect electronic receipts and save and organize them in electronic spaces, which usually entails organizing and saving the emails with which the electronic receipt was sent. Lastly, some consumers may receive an electronic receipt and then generate a paper receipt by printing the electronic receipt. Therefore, in today's world, consumers may store old receipts in one or more locations, both physical and electronic, and the stored receipts are only as organized as the particular consumer's efforts dictate.

Additionally, besides simply storing receipts, consumers face a challenge of remembering why a certain receipt is important. For example, even if a consumer can retrieve an old receipt, the consumer may not remember whether the expenditure was related to business or personal purposes. Particularly diligent consumers may keep written or electronic notes concerning various purchases. However, these notes are neither tied to the consumers' bank account information nor the email accounts in which one or more electronic receipts may be stored. Consequently, the notes are often stored in different places and in places that may not be the most logical and, therefore, may be difficult to retrieve.

Further compounding the problem is the fact that weeks, months, or even years may pass before a consumer needs to use an old receipt. For example, one consumer may need to submit all receipts relating to business expenses to her employer at the end of a month for reimbursement purposes. Another consumer may need to submit all receipts related to charitable contributions to her accountant at the end of the tax year for income deduction purposes. In either of these instances, or the countless other instances in which a consumer has a need to retrieve old receipts, the consumer must rely on her past diligence in storing and organizing receipts across both physical and electronic spaces in order to achieve her intended goal.

In sum, it is clear that current methods of saving receipts have numerous limitations. A consumer may have numerous receipts that are both in paper and electronic form. Additionally, a consumer's electronic receipts may be spread across multiple emails accounts. Furthermore, a consumer has no single space in which to easily store both electronic receipts and the information contained in paper receipts. Lastly, a consumer has no efficient way to store notes concerning both paper and electronic receipts. At best, these limitations of current methods cost consumers their time and sanity as they wade through old paper receipts, email accounts, and old accounting statements to find what they need; at worst, they cost consumers much more—the inability to obtain a refund, a tax deduction, a reimbursement, etc. Therefore, there remains a need for an improved system for assisting a consumer with the collection, retention, and organization of receipts.

### SUMMARY

Embodiments of the invention relate to apparatuses, methods, and computer program products that allow a consumer to submit, store, and manage electronic receipts and transaction annotations arising out of financial transactions. According to some embodiments of the present invention, a consumer first makes a purchase from a merchant. During the course of the purchase or after the purchase has been completed, an electronic receipt is generated and transmitted to the consumer. In some embodiments, after the consumer's purchase has been completed, the merchant generates and transmits the electronic receipt to the consumer's email account. Alternatively, the merchant may transmit the electronic receipt to the consumer's cell phone or other personal mobile electronic device via a text message or picture message. In other embodiments, the consumer may receive a paper receipt from the merchant, and the consumer generates the electronic receipt from the paper receipt. In other embodiments, the electronic receipt is either generated and/or transmitted by a third party that is associated with either the merchant or the consumer, such as a financial institution, based on transaction information transmitted to the third party from the merchant.

In accordance with some embodiments of the present invention, the consumer elects to submit an electronic receipt to the consumer's e-receipt account after making a purchase from a merchant. In some embodiments, where the consumer originally received an electronic receipt, the consumer may upload the electronic receipt directly to the e-receipts account, which is accessible to the consumer online (i.e., via the Internet) or via another similar network, such as a mobile communication network. Alternatively, the consumer may submit the electronic receipt to the e-receipts account by accessing the consumer's online or mobile banking services and attaching the electronic receipt to a purchase. In further embodiments, where the consumer has received a paper receipt, the consumer may use a cell phone or other personal mobile electronic device to take a digital picture of the paper receipt and submit this electronic receipt to the e-receipts account.

Additionally, in some embodiments of the present invention, the user may associate notes or annotations to the electronic receipt before or after it is submitted to the e-receipts account. These notes or annotations may be any text that the consumer wishes to associate with the electronic receipt, such as the purpose for the purchase or whether the consumer expects to be reimbursed.

In accordance with the present invention, once a consumer submits an electronic receipt to the e-receipts account, the electronic receipt is assigned to a purchase. By assigning the electronic receipt to a purchase, a hyperlink to the electronic receipt is made available to the consumer when the consumer accesses the e-receipts account or other online or mobile banking services. In some embodiments, the consumer accesses the e-receipts account and sees a list of e-receipt entries that are each associated with an electronic receipt, where the electronic receipt is assigned to a purchase. Each e-receipt entry may include information about a purchase, including a merchant's name, the date of a purchase, the amount of a receipt, and/or the type of payment that the consumer used to make the purchase. The consumer is able to view the electronic receipt associated with the e-receipt entry by clicking on a hyperlink that may be included in the e-receipt entry.

In accordance with other embodiments of the invention, the consumer may be able to view previously submitted electronic receipts by instead accessing other online or mobile banking services. In one embodiment of the invention, the online or mobile banking service allows the consumer to view all of the consumer's electronic receipts in an e-receipts area of the user interface. In other embodiments, the online or mobile banking service displays the receipts in amongst a list of financial transactions. Each transaction entry may also include a hyperlink that would enable the consumer to view the electronic receipt attached to that transaction entry.

In some embodiments of the invention, viewing an electronic receipt would also include viewing any notes or annotations that the consumer added before submitting the electronic receipt to the e-receipts account. In one embodiment, the notes or annotations would appear directly above the electronic receipt. In other embodiments of the invention, the consumer would have the option to edit any notes or annotations while viewing the electronic receipt.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating an e-receipts collection and management system and the system's environment in accordance with an embodiment of the present invention;

FIG. 2 is a block diagram illustrating a mobile device in accordance with an exemplary embodiment of the present invention;

FIG. 3 is a flow chart illustrating a process for communicating receipt information to a consumer and allowing the consumer to save or submit the receipt in accordance with an embodiment of the invention;

FIG. 4 illustrates an exemplary transaction notification as it may be displayed on a consumer's mobile device, in accordance with an embodiment of the invention;

FIG. 5 illustrates an exemplary electronic receipt as displayed on a mobile device in response to a consumer selecting a hyperlink in the transaction notification;

FIG. 6 illustrates a second example of a transaction notification as it may be displayed on a consumer's mobile device, in accordance with an embodiment of the invention;

FIG. 7 is a representation of a graphical user interface of a mobile banking application according to one embodiment of the invention;

FIG. 8 provides a flow chart illustrating another method of submitting electronic receipts in accordance with some embodiments of the invention;

FIG. 9 is illustrates an exemplary user interface that is displayed on a mobile device to allow a consumer to create annotations and associate them with a receipt or transaction;

FIG. 10 illustrates a mobile banking application's user interface displayed on a consumer's mobile device, in accordance with an embodiment of the invention;

FIG. 11 illustrates the mobile device in camera mode following the consumer selecting to attach a photo of a paper receipt, in accordance with an embodiment of the invention;

FIG. 12 allows the consumer to view electronic receipts attached to a transaction and use the links to add to, modify, or delete the receipt and/or receipt annotations;

FIGS. 13A, 13B, and 13C illustrate different views and web pages of an online banking platform that a consumer can access via the Internet and use to view and manage transaction information, electronic receipts, and annotations in accordance with an embodiment of the invention; and

FIG. 14 is a representation of one embodiment of an online banking web page where the consumer can control the e-receipt settings.

### DETAILED DESCRIPTION OF EMBODIMENTS OF THE INVENTION

In general, embodiments of the present invention concern the collection and management of a consumer's detailed receipt information in electronic form (“electronic receipts” or “e-receipts”) and the storage of the electronic receipts in an “e-receipts account”, which is accessible to the consumer online or through the consumer's personal mobile electronic device. In some embodiments, the e-receipts account is managed by a financial institution already managing at least one financial account of the consumer, for example, a credit account or a checking account, also referred to as a demand deposit account or, more generally, a deposit account. Indeed, in some cases, the e-receipts account may be incorporated, in whole or in part, into the online banking services already provided by the bank to the consumer.

In general, according to some embodiments of the present invention, a consumer first makes a purchase from a merchant or other vendor. During the course of the purchase or after the purchase has been completed, an electronic receipt is generated and transmitted to the consumer. This could happen in a number of different ways. In some embodiments, after the consumer's purchase has been completed, the merchant generates and transmits the electronic receipt to the consumer's email account. Alternatively, the merchant may transmit the electronic receipt to the consumer's cell phone or other personal mobile electronic device via a text message or picture message. In other embodiments, the consumer may receive a paper receipt from the merchant, and the consumer generates the electronic receipt from the paper receipt. The consumer could generate the electronic receipt in any number of ways, including, taking a digital photograph of the electronic receipt, scanning the electronic receipt, or typing the contents of the electronic receipt into a digital word processing document or spreadsheet. In other embodiments, the electronic receipt is either generated and/or transmitted by a third party that is associated with either the merchant or consumer, such as a financial institution, based on receipt information transmitted to the third party from the merchant.

In accordance with some embodiments of the present invention, the consumer elects to submit an electronic receipt to the consumer's e-receipt account after making a purchase from a merchant. In some embodiments, where the consumer originally received an electronic receipt, the consumer may upload the electronic receipt directly to the e-receipts account, which is accessible to the consumer online (i.e., via the Internet) or via another similar network, such as a mobile communication network. Alternatively, the consumer may submit the electronic receipt to the e-receipts account by accessing the consumer's online or mobile banking services and attaching the electronic receipt to a purchase. In further embodiments, where the consumer has received a paper receipt, the consumer may use a cell phone or other personal mobile electronic device to take a digital picture of the paper receipt and submit this electronic receipt to the e-receipts account.

Additionally, in some embodiments of the present invention, the user may associate notes or annotations to the electronic receipt before or after it is submitted to the e-receipts account. These notes or annotations may be any text that the consumer wishes to associate with the electronic receipt, such as the purpose for the purchase or whether the consumer expects to be reimbursed.

In accordance with the present invention, once a consumer submits an electronic receipt to the e-receipts account, the electronic receipt is assigned to a purchase. By assigning the electronic receipt to a purchase, a hyperlink to the electronic receipt is made available to the consumer when the consumer accesses the e-receipts account or other online or mobile banking services. In some embodiments, the consumer accesses the e-receipts account and sees a list of e-receipt entries that are each associated with an electronic receipt, where the electronic receipt is assigned to a purchase. Each e-receipt entry may include information about a purchase, including a merchant's name, the date of a purchase, the amount of a receipt, and/or the type of payment that the consumer used to make the purchase. The consumer is able to view the electronic receipt associated with the e-receipt entry by clicking on a hyperlink that may be included in the e-receipt entry. As used in relation to the present invention, the date of a purchase may be the date that the consumer made the purchase from the merchant or it may also mean the date that the purchase was processed by a third party, such a financial institution, that was involved in the purchase between the consumer and merchant.

In accordance with other embodiments of the invention, the consumer may be able to view previously submitted electronic receipts by instead accessing other online or mobile banking services. In one embodiment of the invention, the online or mobile banking service allows the consumer to view all of the consumer's electronic receipts in an e-receipts area of the user interface. In other embodiments, the online or mobile banking service displays the receipts in amongst a list of financial transactions. For example, each transaction entry in the list may include information about a consumer's purchase, including a merchant's name, the date of a purchase, and/or the amount of a transaction, such as a purchase. Each transaction entry may also include a hyperlink that would enable the consumer to view the electronic receipt attached to that transaction entry.

In some embodiments of the invention, viewing an electronic receipt would also include viewing any notes or annotations that the consumer added before submitting the electronic receipt to the e-receipts account. In one embodiment, the notes or annotations would appear directly above the electronic receipt. In other embodiments of the invention, the consumer would have the option to edit any notes or annotations while viewing the electronic receipt.

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein, unless the claims clearly indicate otherwise; rather, these embodiments are provided so that this disclosure will satisfy applicable legal requirements. Like numbers refer to like elements throughout.

### E-Receipts Collection and Management System

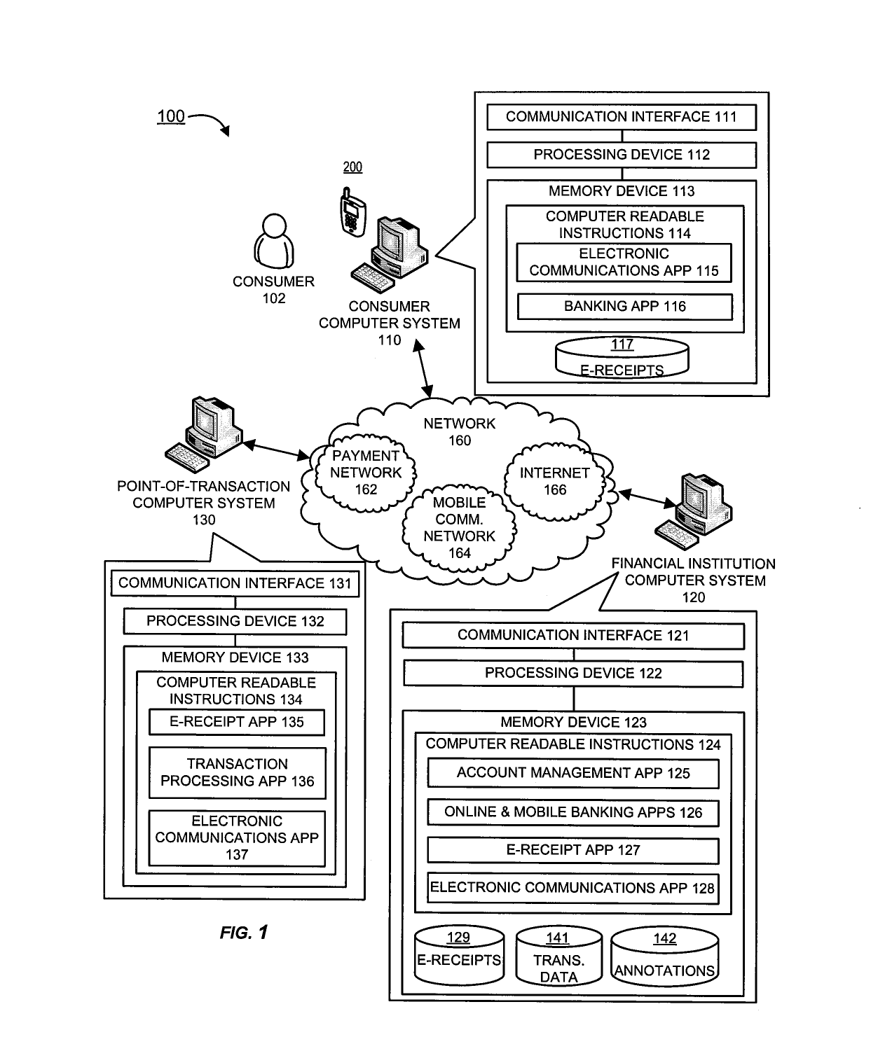

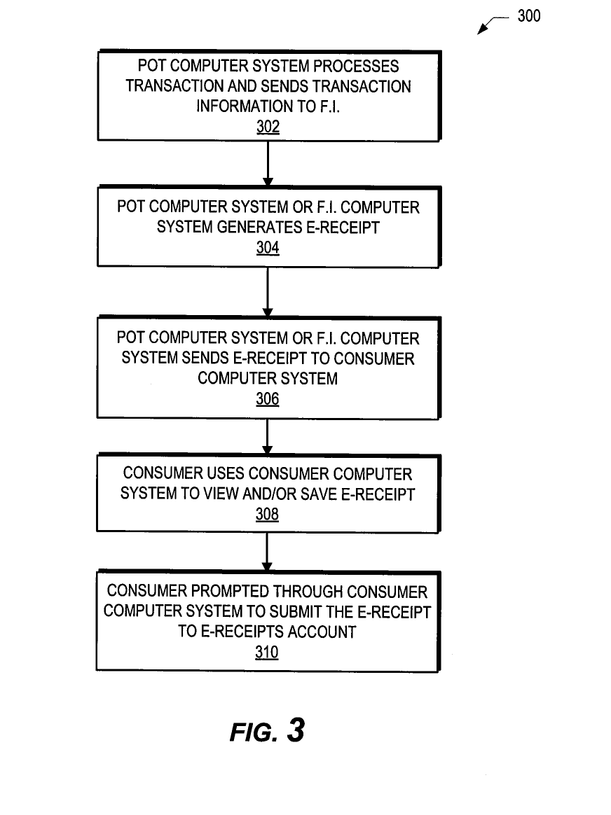

FIG. 1 illustrates an exemplary electronic receipts collection and management system environment in which an embodiment of the present invention exists. As described in greater detail below, the system 100 is configured to perform the methods described herein, including those described in relation to FIGS. 3-14.

As shown in FIG. 1, in one embodiment, the electronic receipts collection and management system 100 includes a consumer computer system 110, a point-of-transaction (“POT”) computer system 130, and a financial institution computer system 120. Although, for simplicity, FIG. 1 only illustrates one of each computer system, it will be appreciated that, in some embodiments of the invention, there will be many consumer computer systems 110, many POT computer systems 120, and/or many financial institution computer systems 120. As used herein and in the claims, the term “financial institution” refers to an institution that provides financial services to its clients or members by, for example, processing financial transactions for its clients or members. Financial institutions can include, but are not limited to, banks, building societies, credit unions, stock brokerages, asset management firms, savings and loans, money lending companies, insurance brokerages, insurance underwriters, dealers in securities, and similar businesses. Retail, wholesale, and service businesses, as well as manufacturers, may also process financial transactions as disclosed herein.

Referring again to the embodiment illustrated in FIG. 1, the consumer computer system 110 and the point-of-transaction (“POT”) computer system 130 are operatively coupled, via a network 160, to the bank computer system 120. The network 160 include a global area network (GAN), such as the Internet 166, a wide area network (WAN), a local area network (LAN), or any other type of network or combination of networks. For example, in some embodiments of the invention the network 160 includes a payment network 162 and a mobile communication network 164. A payment network 162 is generally a network of one or more financial institutions and devices that allow for secure transmission of financial payment information. For example, when a consumer makes a purchase using an electronic payment vehicle, such as a credit or debit card, the POT computer system 130 communicates the credit or debit card number, transaction information, and authentication information (e.g., a PIN) via the payment network to the financial institution computer system 120 that issued the card. The financial institution computer system 120 then responds via the payment network 162 with an authorization decision regarding the requested transaction. The mobile communication network 164 is a cellular network and/or other data communication network that communicates information to wireless devices, such as mobile phones and the like. The network 160 may provide for wireline, wireless, or a combination of wireline and wireless communication between devices in the network.

It will be understood that when two components are described herein as communicating over a network, the components may be directly coupled to each other or indirectly coupled via one or more other components. Furthermore, although at least some of the systems described herein are described as having several unique components, these components need not be separate and distinct from one another, and two or more of such components may, in some embodiments, be combined into a single component that performs all of the functions of the multiple components so combined as described herein. Additionally, in some embodiments of the present invention, certain functions of one component may be combined into another component as described herein.

As illustrated in FIG. 1, the consumer computer system 110 generally comprises a communication interface 111, a processing device 112, and a memory device 113. The processing device 112 is operatively coupled to the communication interface 111 and the memory device 113. The processing device 112 uses the communication interface 111 to communicate with the financial institution computer system 120 and/or POT computer system 130 over the network 160. The processing device 112 also uses the communication interface 111 to communicate with the consumer 102. As such, the communication interface 111 generally comprises a modem, server, wireless card, radio, and/or other network interface device for communicating with other devices on the network 160, and a display, mouse, keyboard, microphone, touch pad, touch screen, speaker, camera, and/or other user input/output devices for communicating with the consumer 102.

As used herein and in the claims, the term “processing device” generally refers to circuitry used for implementing communication and logic functions of the system in which it resides. A processing device may include, for example, a digital signal processor device, a microprocessor device, and various analog-to-digital converters, digital-to-analog converters, and other support circuits. Control and signal processing functions of a system are allocated between these processing devices according to their respective capabilities. The processing device may also include functionality to operate one or more computer applications based on computer-readable instructions (i.e., computer program code) thereof, which may be stored in a memory device in communication therewith. As used herein and in the claims, the term “memory device” generally refers to any device having computer-readable medium configured to store, for example, data and/or one or more computer applications.

As further illustrated in FIG. 1, the consumer computer system 110 includes computer-readable instructions 114 stored in the memory device 113, which include the computer-readable instructions 114 of an electronic communications application 115 and, in some embodiments, a banking application 116. The electronic communications application 115 includes computer-readable instructions that, when executed by the processing device 112, allow the consumer 102 to receive, store, and transmit electronic messages utilizing the communication interface 111. For example, in one embodiment of the present invention, the electronic communications application 115 may include an SMS (Short Message Service) text messaging application, an email application, and/or a picture messaging application. The banking application 116 may be an application that is downloaded to the consumer computer system 110 from a financial institution computer system 120 that assists the consumer with banking services when the consumer 102 is utilizing the consumer computer system 110.

In some embodiments of the invention, the memory 113 of the consumer computer system 110 also include one or more e-receipts 117 stored therein. E-receipts 117 are electronic versions of a receipt from a financial transaction. These e-receipts 117 may be image documents, text documents, Word documents, PDF documents, and/or any other format of document that includes itemized information about a transaction, such as a purchase transaction. The e-receipt may be the only receipt generated or it may represent a copy, scan, or image of a paper receipt.

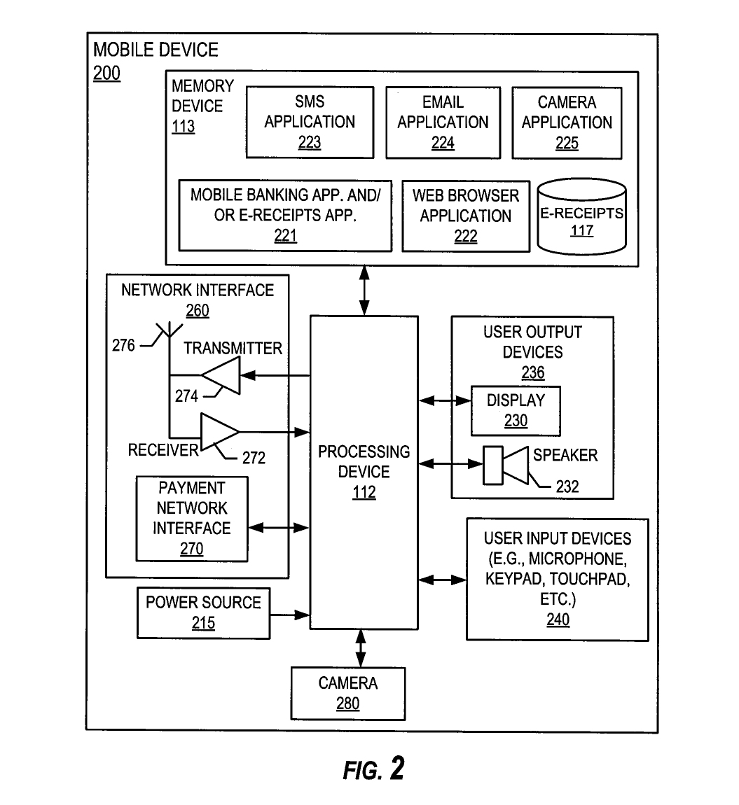

In one embodiment, the consumer computer system 110 is a consumer's desktop computer. In other embodiments, however, the consumer computer system 110 is a consumer's mobile computing device, which may include, for example, a mobile telephone, a personal digital assistant, a mobile picture taking device, a laptop computer, a mobile email device, a mobile texting device, a mobile music device, a wrist computer, and/or any other mobile terminal. In this regard, FIG. 2 illustrates an exemplary embodiment of the invention where the consumer computer system 110 is a mobile device 200. FIG. 2 is described in greater detail below.

As illustrated in FIG. 1, the financial institution computer system 120 generally includes a communication interface 121, a processing device 122, and a memory device 123. The processing device 122 is operatively coupled to the communication interface 121 and the memory device 123. The processing device 122 uses the communication interface 121 to communicate with the consumer computer system 110 and the POT computer system 130 over the network 160. As such, the communication interface 121 generally comprises a modem, server, wireless card, radio or other device for communicating with other devices on the network 160.

As further illustrated in FIG. 1, the financial institution computer system 120 includes computer-readable instructions 124 stored in the memory device 123, which include the computer-readable instructions 124 of an account management application 125, an online and mobile banking application 126, an e-receipt application 127, and an electronic communications application 128. The account management application 125 includes computer code that, when executed by the processing device 122, perform functions such as storing, organizing, and otherwise managing transaction information related to each of the different accounts that are managed by the financial institution. The online and mobile banking application 126 provides an interactive web-based or mobile-device-based banking platform that may be accessed by account holders to view their various accounts and perform certain transactions, such as transaction inquiries, fund transfers, bill payments, etc. The e-receipt application 127 includes computer code that, when executed by the processing device 122, perform functions such as storing, organizing, and otherwise managing the electronic receipts belonging to the consumer 102. Finally, the electronic communications application 128 includes one or more computer programs for receiving, storing, and transmitting electronic messages utilizing the communication interface 121 and network 160.

The memory 123 of the financial institution computer system 120 also includes data stored therein, such as transaction data 141 related to each financial transaction that it processes or is otherwise involved in, e-receipts 129, and transaction annotations 142 created by the consumer 102.

In some embodiments of the invention, the financial institution computer system 120 is operated by or on behalf of a banking institution that maintains one or more financial accounts for the consumer 102 (hereinafter referred to as the “bank”). Although FIG. 1 illustrates the financial institution computer system 120 as one system, it is important to note that there can be one or multiple systems, each with similar components that handle the various functions of the financial institution computer system 120.

The POT computer system 130, also sometimes referred to as a point-of-sale (POS) computer system/terminal, generally includes a communication interface 131, a processing device 132, and a memory device 133. The processing device 132 is operatively coupled to the communication interface 131 and the memory device 133. The processing device 132 uses the communication interface 131 to communicate with the financial institution computer system 120 and, in some cases, the consumer computer system 110 over the network 160. As such, the communication interface 131 generally comprises a modem, server, or other device(s) for communicating with other devices on the network 160. The processing device 132 also uses the communication interface 131 to communicate with the consumer 102 or other consumer devices, such as consumer payment devices. As such, the communication interface 131 generally includes input and output devices such as one or more magnetic stripe readers, near-field-communication (NFC) devices, keypads, touch screens, display devices, and/or the like. As used herein, the POT computer system 130 represents the merchant's computer system which may include both one or more computers located at the POT and one or more computers remote from the actual POT but in communication with the computers at the POT.

As further illustrated in FIG. 1, the POT computer system 130 has computer-readable program instructions 134 stored in the memory device 133, including computer-readable instructions 134 of, in some embodiments, an electronic receipts application 135, a transaction processing application 136, and an electronic communications application 137. The electronic receipts application 135 generally includes computer program code that, when executed by the processing device 132, generates the transmission of electronic receipts or other receipt information. The payment processing application 136 generally includes computer program code that, when executed by the processing device 132, performs payment processing functions. For example, in the case of a debit card payment, the payment processing functions may include reading the debit card, contacting the issuing entity, requesting authorization from the issuing entity, receiving authorization from the issuing entity, and receiving the payment. The electronic communications application 137 includes one or more computer programs for receiving, storing, and transmitting electronic messages utilizing the communication device 131.

Although FIG. 1 illustrates the POT computer system 130 as one system, it is important to note that there can be one or multiple systems, each with similar components that handle functions herein attributed to the POT computer system 130.

As described above, in some embodiments of the invention the consumer computer system 110 is a mobile device 200, such as a mobile smart phone. FIG. 2 illustrates a block diagram of a mobile device in greater detail in accordance with an embodiment of the invention. In one embodiment of the invention, the mobile device 200 is a mobile telephone. However, it should be understood, however, that a mobile telephone is merely illustrative of one type of mobile device 200 that may benefit from, employ, or otherwise be involved with embodiments of the present invention. Other types of mobile devices 200 may include portable digital assistants (PDAs), pagers, mobile televisions, gaming devices, laptop computers, cameras, video recorders, audio/video player, radio, GPS devices, or any combination of the aforementioned.

As described with respect to FIG. 1, the mobile device 200 generally includes a processing device 112. The processing device 112 is communicably coupled to such devices as the memory device 113, user output devices 236, user input devices 240, a network interface 260, a power source 215, and a camera 280. The processing device 112, and other processors described herein, generally include circuitry for implementing communication and/or logic functions of the mobile device 200. For example, the processing device 112 may include a digital signal processor device, a microprocessor device, and various analog to digital converters, digital to analog converters, and/or other support circuits. Control and signal processing functions of the mobile device 200 are allocated between these devices according to their respective capabilities. The processing device 112 thus may also include the functionality to encode and interleave messages and data prior to modulation and transmission. The processing device 112 can additionally include an internal data modem.

Further, the processing device 112 may include functionality to operate one or more software programs, which may be stored in the memory 113. For example, the processing device 112 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like.

The processing device 112 is configured to use the network interface 260 to communicate with one or more other devices on the network 160. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the mobile communication network 164. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 200 may also be configured to operate in accordance with non-cellular communication mechanisms, such as via a wireless local area network (WLAN) or other communication/data networks.

The network interface 260 may also include a payment network interface 270. The payment network interface 270 may include software, such as encryption software, and hardware, such as a modem, for communicating information to and/or from one or more devices on a payment network 162. For example, the mobile device 200 may be configured so that it can be used as a credit or debit card by, for example, wirelessly communicating account numbers or other authentication information to the POT computer system 130.

As described above, the mobile device 200 has a user interface that, like other user interfaces described herein, is made up of user output devices 236 and/or user input devices 240. The user output devices 236 include a display 230 (e.g., a liquid crystal display or the like) and a speaker 232 or other audio device, which are operatively coupled to the processing device 112. The user input devices 240, which allow the mobile device 200 to receive data from a user such as the consumer 102, may include any of a number of devices allowing the mobile device 200 to receive data from a user, such as a keypad, keyboard, touch-screen, touchpad, microphone, mouse, joystick, other pointer device, button, soft key, and/or other input device(s). The user interface may also include a camera 280, such as a digital camera. In general, the mobile device 200 uses the display 230 as the camera's viewfinder and to display a recently-recorded picture during camera mode.

The mobile device 200 further includes a power source 215, such as a battery, for powering various circuits and other devices that are used to operate the mobile device 200. Embodiments of the mobile device 200 may also include a clock or other timer configured to determine and, in some cases, communicate actual or relative time to the processing device 112 or one or more other devices.

The mobile device 200 also includes a memory device 113 operatively coupled to the processing device 112. As used herein, memory includes any computer readable medium (as defined herein below) configured to store data, code, or other information. The memory 113 may include volatile memory, such as volatile Random Access Memory (RAM) including a cache area for the temporary storage of data. The memory 113 may also include non-volatile memory, which can be embedded and/or may be removable. The non-volatile memory can additionally or alternatively include an electrically erasable programmable read-only memory (EEPROM), flash memory or the like.

The memory 113 can store any of a number of applications which comprise computer-executable instructions/code executed by the processing device 112 to implement the functions of the mobile device 200 described herein. For example, the memory 113 may include such applications as a conventional web browser application 222 and/or an e-receipts application and/or other mobile banking application 221. These applications also typically provide a graphical user interface (GUI) on the display 230 that allows the consumer 102 to communicate with the mobile device 200, the financial institution computer system 120, and/or other devices or systems. In other embodiments of the invention, the consumer 102 interacts with the financial institution computer system 120 via the web browser application 222 in addition to, or instead of, the e-receipts or mobile banking application 221. The memory device 113 also generally includes an SMS application 223 (i.e., a text or image messaging service application), an email application 224, and/or other applications that allow communication to and/or from the mobile device 200.

The memory 113 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as the electronic receipts 117, etc.

### Receiving and Storing an E-Receipt

With reference now to FIG. 3, a flow chart illustrating a method 300 of submitting electronic receipts in accordance with embodiments of the invention is provided. In particular, FIG. 3 represents an exemplary method of submitting an electronic receipt to the financial institution computer system 120 where the electronic receipt is first transmitted to the consumer 102 from a POT transaction system 130 (i.e., from the merchant), a financial institution computer system 120, or from some other system.

As represented by block 302 in FIG. 2, the consumer 102 first makes a purchase that gives rise to a receipt. The POT computer system 130 processes the transaction and sends transaction information to the financial institution computer system 120. The purchase may be made in-store, online, via telephone, or otherwise. Although exemplary embodiments of the present invention are generally described herein with regard to a “purchase”, i.e., a monetary value exchanged for goods or services, other embodiments of the invention may involve other transactions where a receipt is generated. For example, such other transactions may include charitable donations, returns of merchandise, refunds, bank deposits, cash withdrawals, gifts, and/or the like. Thus, it should be clear that the use of the term “purchase” in the description of exemplary embodiments of the invention does not limit the nature of financial transaction that may be the subject of other embodiments of the present invention unless the context clearly indicates otherwise.

As represented by block 304, once the consumer's purchase has been completed, an electronic receipt corresponding to the purchase is generated by either the POT computer system 130 or the financial institution computer system 120. This electronic receipt contains information related to a particular bank account of consumer 102 used in the transaction. In some embodiments of the invention, the electronic receipt includes itemized transaction information and provides information about how the purchase affects the balance of the bank account. In some embodiments, the computer system is configured to generate electronic receipts that look like a traditional paper receipt.

In some embodiments of the invention, the merchant (i.e., the POT computer system 130) generates the electronic receipt either automatically, or alternatively, at the direction of the consumer 102. In other embodiments of the invention, when the consumer 102 uses a payment method that is associated with a financial institution, the financial institution (i.e., the financial institution computer system 120) generates an electronic receipt based on the transaction information received from the POT computer system 130. In some embodiments, the computer systems are configured to generate electronic receipts that look like a traditional paper receipt. Alternatively, the financial institution may direct the merchant to generate the electronic receipt. In some embodiments of the invention, the financial institution knows to either direct the merchant to generate an electronic receipt or generate an electronic receipt itself because the consumer 102 previously provided the financial institution with preferences concerning when consumer 102 would like to receive electronic receipts. These preferences are stored in the memory 123 of the financial institution computer system 120 and associated with the consumer 102 and/or the consumer's account(s).

At block 306, the electronic receipt is transmitted to consumer computer system 110 by either the POT computer system 130 or the financial institution computer system 120, as the case may be. In some embodiments of the invention, the electronic receipt is transmitted to an email address associated with consumer 102. The consumer 102 then uses the web browser application or an email application stored on the consumer computer system 111 to access the receipt. In other embodiments of the invention, the electronic receipt may be transmitted as part of a transaction notification directly to the consumer computer system 110. Such a notification may be transmitted via a text messaging application or picture messaging application (e.g., SMS, MMS, etc.). As would be appreciated by one of ordinary skill in the art, the transmission of the electronic receipt to the consumer 102, either through email or through the use of a transaction notification, presents the consumer 102 with information about a transaction associated made by the consumer 102 or using the consumer's financial account.

In some embodiments of the invention, the merchant transmits the electronic receipt to consumer 102 by way of the POT computer system 130 automatically after the transaction is completed (based on pre-stored consumer preferences). The merchant may transmit the electronic receipt to consumer 102 in a variety of ways. In one embodiment, the merchant' POT computer system 120 may email the electronic receipt to one or more email addresses associated with consumer 102. The computer system 120 may have already stored the one or more email address of consumer 102 (for instance, if the consumer 102 had previously shopped with the merchant) or it may request that the consumer 102 provide the one or more email addresses at the time of purchase. In another embodiment, the merchant's computer system 120 may transmit the electronic receipt as part of a transaction notification communicated via a text or picture messaging service.

In yet another embodiment of the invention, the consumer 102 may provide one or more email addresses or telephone numbers to a financial institution that is associated with a payment method that the consumer 102 may use during a transaction. Thus, when consumer 102 uses that payment method to complete a purchase or other transaction, the financial institution computer system 110 directs the merchant's POT computer system 130 to transmit the electronic receipt to the one or more email addresses or cell phone numbers that consumer 102 provided to the financial institution. Alternatively, if the financial institution is generating the electronic receipt, then the financial institution may transmit the electronic receipt to consumer 102. In still another embodiment, the merchant's POT computer system 130 generates the receipt and then communicates it to the financial institution computer system 120, which then forwards the electronic receipt on to the consumer's consumer computer system 110 via an appropriate messaging service.

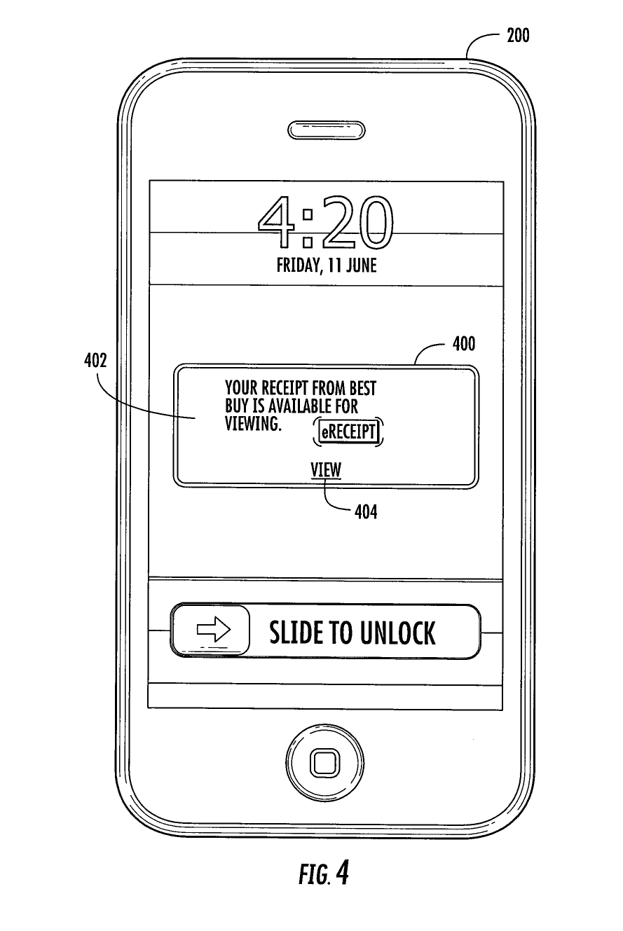

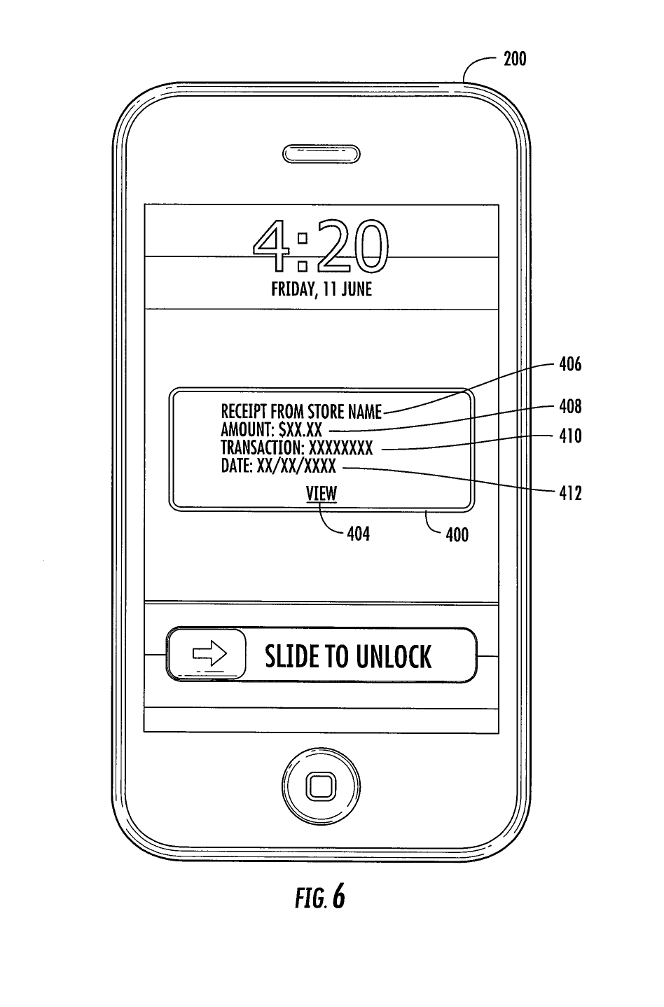

FIGS. 4 and 6 represent different embodiments of a transaction notification displayed on a consumer's mobile device 200 (i.e., a consumer computer system 110), in accordance with an embodiment of the invention. In FIG. 4, notification 400 includes an indication 402 that an electronic receipt from a merchant is available for viewing. Notification 400 may also include a hyperlink 404 that would prompt consumer 102 to view an electronic receipt on consumer computer system 110. FIG. 6 is another embodiment of notification 400. As represented in FIG. 6, notification 400 may include an indication 406 of the name of the merchant with which consumer 102 completed a purchase. Notification 400 may also include an indication 408 of the total amount of the purchase. Notification 400 may also include an indication 410 that comprises alphanumeric characters used by merchant to identify the purchase. As displayed in FIG. 4, notification 400 may also include an indication 412 that indicates the date of a purchase. Notification 400 may also include a hyperlink 404 that would prompt consumer 102 to view an electronic receipt on the consumer computer system 110. In some embodiments of the invention, the notification 400 may include other information such as, for example, itemized transaction information like stock-keeping unit (SKU) data, UPC data, and the like relating to the purchase of consumer 102.

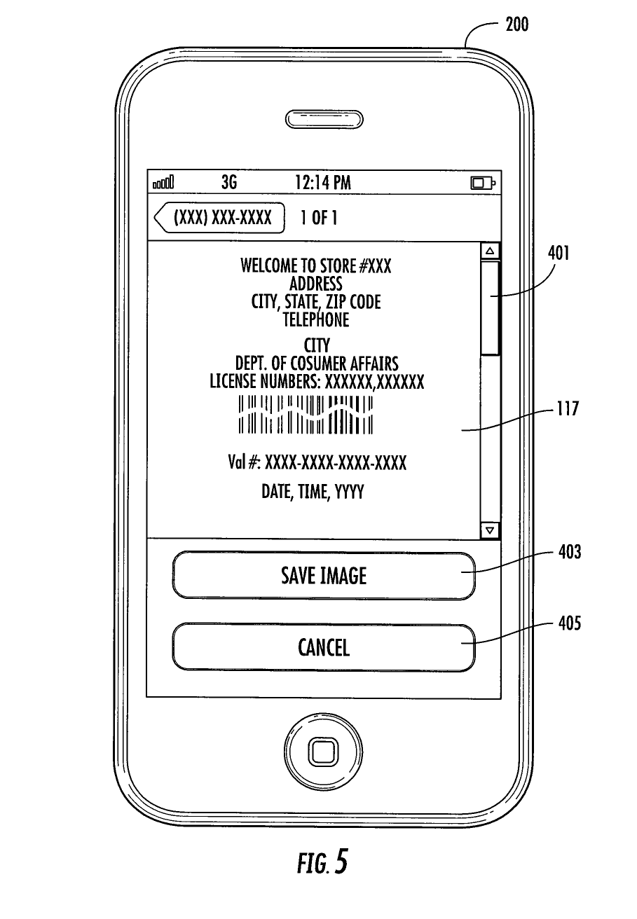

Returning again to FIG. 3, after the POT or financial institution computer system has transmitted the electronic receipt to consumer 102 as represented in block 306, the consumer 102 uses the consumer computer system 110 to view and/or save the electronic receipt as indicated in block 308. According to some embodiments of the invention, the consumer 102 may view the electronic receipt by accessing the email account or accounts to which the electronic receipt was transmitted. In other embodiments, where the consumer 102 has received a notification 400, the consumer 102 may view the electronic receipt by following hyperlink 404 and viewing the electronic receipt on the display of the consumer computer system 110. For example, FIG. 5 illustrates the mobile device 200 displaying an interface 401 that presents the electronic receipt 117 to the consumer 102 in response to the hyperlink 404 being selected by the consumer 102. As one of ordinary skill in the art would appreciate, regardless of whether the electronic receipt is transmitted to consumer 102 via email, text message, picture message or any other method, consumer 102 may save a copy of the electronic receipt to the memory device 113 of consumer computer system 110. In the embodiment illustrated in FIG. 5, the graphical user interface provides an input mechanism 403 (e.g., a touch screen “button”) to allow the consumer 102 to save the electronic receipt to the mobile device's memory and another input mechanism 405 to allow the consumer 102 to exit out of the illustrated interface without saving the electronic receipt.

At block 310, the consumer 102 is prompted through the consumer computer system 110 to use the consumer computer system 110 to submit an electronic receipt to the e-receipts management system of the financial institution computer system 120. In one embodiment of the invention, the input mechanism 403 also causes the electronic receipt to be sent to and/or saved in the memory of the financial institution computer system 120 or the interface 401 provides another input mechanism for this purpose.

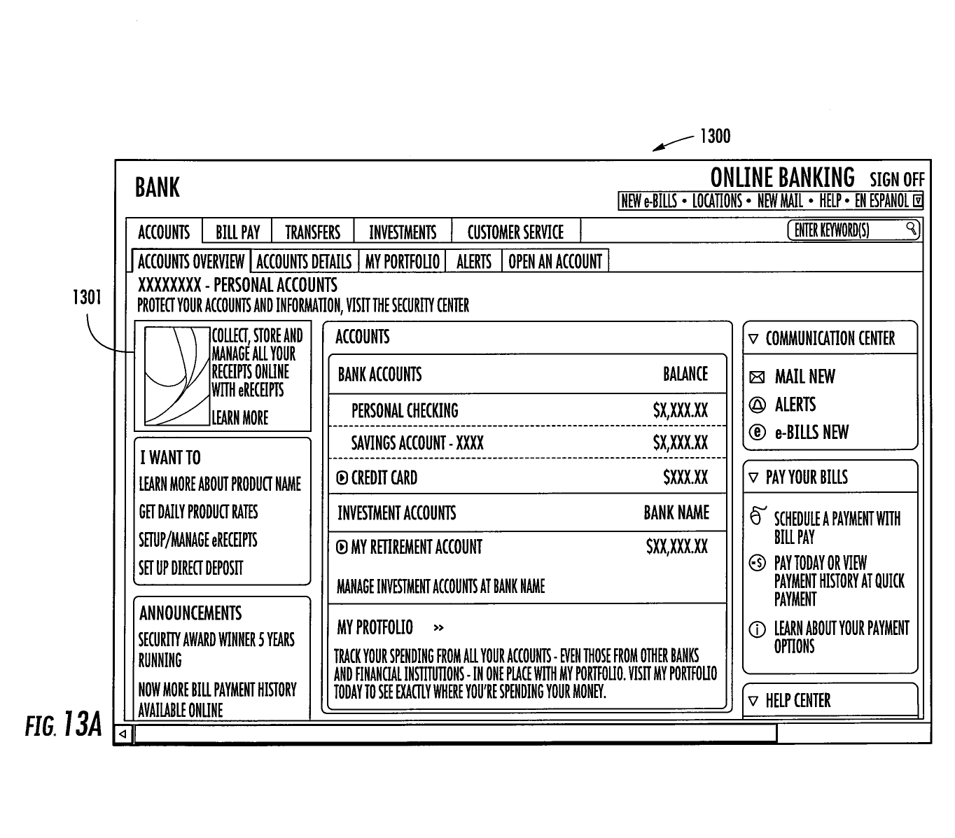

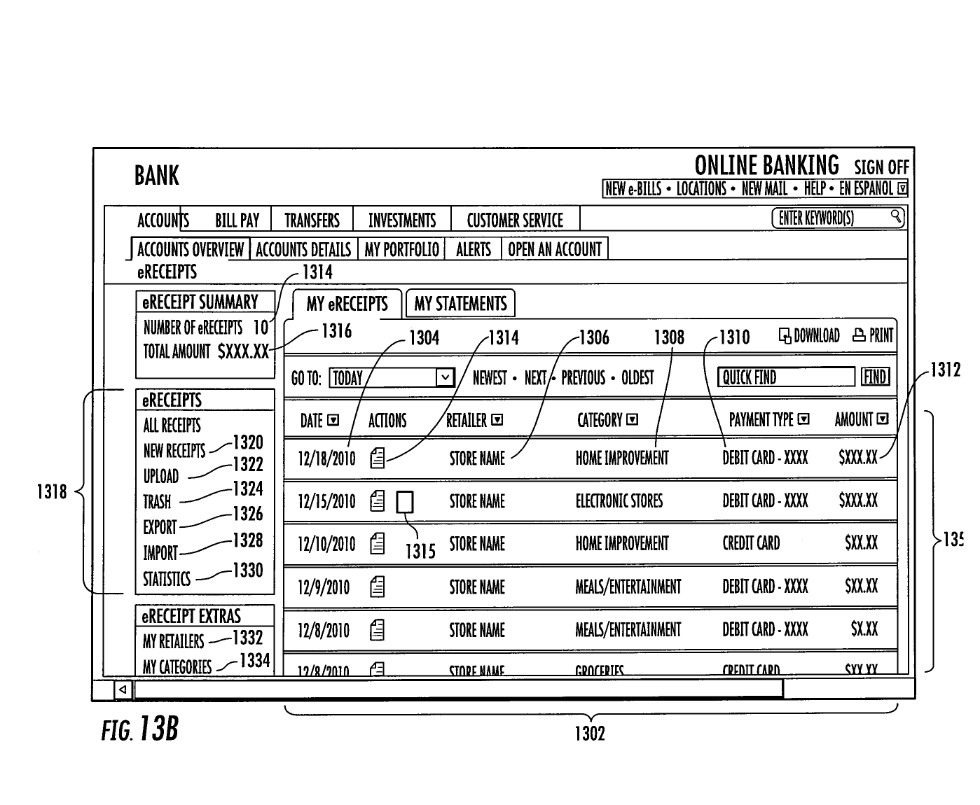

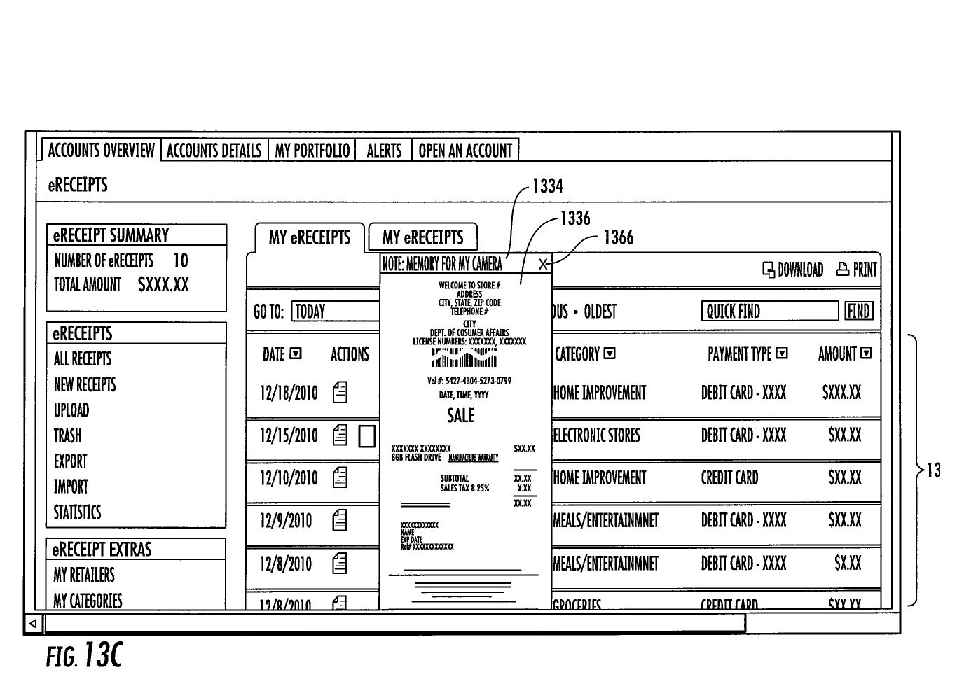

In another embodiment of the invention, the consumer 102 uses consumer computer system 110 to directly access an e-receipt application 127 located on the financial institution computer system 120. For example, the consumer could use a consumer computer system 110 to access an online or mobile banking portal via the Internet and a web browser or mobile application. The consumer 102 may then submit an electronic receipt 117 from the memory device 113 to an e-receipt application 127 of the financial institution computer system 120 by following an upload hyperlink 1322 of an online banking website (see, for example, FIG. 13B). As one of ordinary skill in the art would appreciate, the upload hyperlink 1322 prompts the consumer 102 to submit the electronic receipt to the financial institution computer system 120, where it is received by e-receipt application 127. Either before or after receipt by e-receipt application 127, the electronic receipt will be assigned to a transaction.

In some embodiments, the e-receipt application 127 analyzes the electronic receipt to identify transaction information contained therein. For instance, the e-receipt application 127 may identify the merchant displayed in the electronic receipt, the date of the electronic receipt, the total amount of the electronic receipt or any other information or data contained in therein and then create an e-receipt entry 1302 based upon this information.

In other embodiments, the consumer 102 instead manually adds the transaction information contained within e-receipt entry 1302 before, during, or after uploading the electronic receipt.

In still other embodiments, the financial institution computer system 120 knows which transaction the electronic receipt pertains to by virtue of the consumer 102 submitting the receipt in response to a particular transaction notification or through a transaction-associated e-receipts hyperlink. In such an embodiment, the financial institution may already know some of the details of the transaction from the transaction information received from the POT computer system 130 during processing of the transaction. The financial institution computer system 120 may, however, still gather additional information from the receipt using, for example, character recognition software.

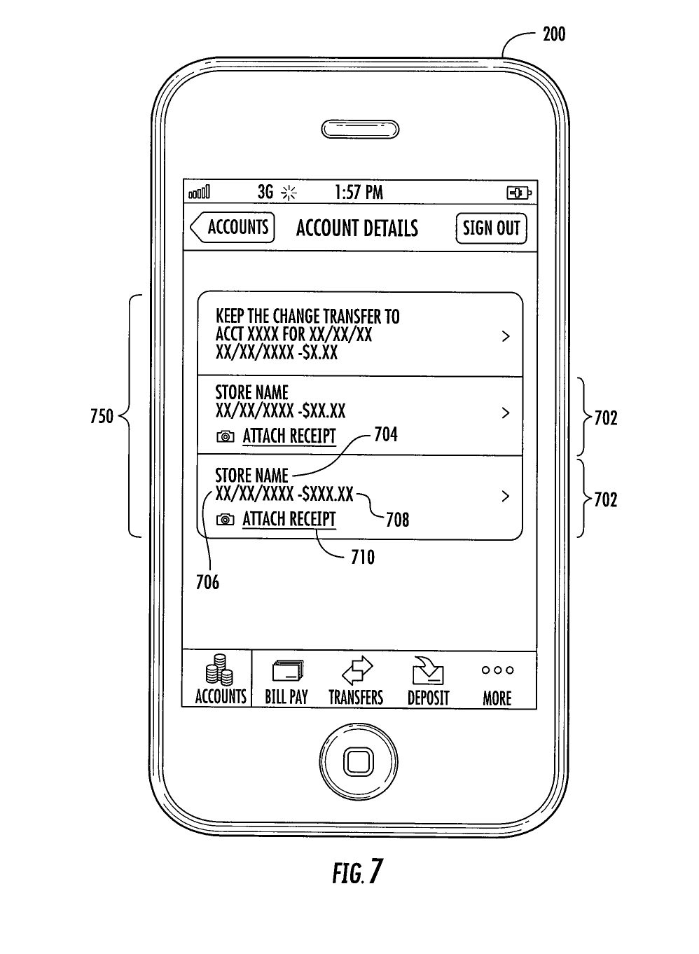

In another embodiment of block 310, the consumer 102 uses the mobile device to execute a mobile banking application 221 which communicates with a mobile banking application 126 of the financial institution computer system 120. FIG. 7 is a representation of a graphical user interface of a mobile banking application according to one embodiment of the invention. The processing device 112 executing the mobile banking application 221 displays a list of transactions 750 that includes one or more purchase entries 702 that are related to one or more accounts associated with the consumer 102. Each purchase entry 702 may contain information about a purchase, including any one or more of the following data: a merchant 704, a date 706, and an amount 708. The merchant 704 is the name of the merchant from which a purchase was made. The date 706 is the date on which a purchase was made. The amount 708 is the total amount of a purchase. Each purchase entry 702 may also include attachment hyperlink 710. Attachment hyperlink 710 may comprise an image and/or text and in some embodiments, attachment hyperlink 710 may be combined with entry 702, merchant 704, date 706, or amount 708.

Referring back to the embodiment of block 310, attachment hyperlink 710 prompts the consumer 102 to attach an electronic receipt 117 stored in the memory device 113 to a specific purchase entry 702 and to submit the electronic receipt 117 to financial institution computer system 120. As one of ordinary skill in the art would appreciate, by following attachment hyperlink 710, the electronic receipt 117 is submitted to the financial institution computer system 120, received by the computer system's e-receipt application 127, and then associated in memory 123 to the purchase described by purchase entry 702.

Additionally, in some embodiments of block 310, consumer 102 may be prompted to add notes or annotations to the electronic receipt 117 before or after submitting the electronic receipt 117 to the financial institution computer system 120. These notes or annotations may include any text that consumer 102 wants to associate with the electronic receipt, such as whether the purchase was for business or personal purposes or whether the consumer 102 expects to be reimbursed for the purchase, etc. When the consumer 102 later views the electronic receipt via online or mobile banking platforms, these notes and annotations will be displayed along with the annotated receipt.

Furthermore, it should be noted that according to some embodiments of the invention, the consumer 102 may submit any electronic receipt 117 that is stored in the memory device 113 to the financial institution computer system 120. While the flowchart of FIG. 3 focuses on embodiments in which the consumer 102 uploads an electronic receipt 117 that was originally transmitted to the consumer 102, one of ordinary skill in the art would appreciate that the consumer 102 could upload any electronic receipt that is stored in the memory device 113. For instance, as described in greater detail below, the consumer 102 could use an image scanner, digital camera, or other image capture device to generate an electronic receipt 117 from a paper receipt and then store that electronic receipt in the memory device 113. Regardless of how the consumer 102 stores an electronic receipt 117 in the memory device 113 (e.g., by saving an attachment of an email, by saving the output file of an image scanner, by saving the output image of a digital camera, etc.), that electronic receipt 117 may be submitted to the e-receipt application 127 of the financial institution computer system 120 by following the upload hyperlink 1322 of the online banking website or the attachment hyperlink 710 of the mobile banking application interface.

While the consumer 102 may be provided with an electronic receipt at the end of a purchase, there may still be occasions where the consumer 102 receives only a paper receipt. For instance, the merchant may lack the capacity to provide electronic receipts for purchases. Additionally, the consumer 102 may forget to request an electronic receipt or the consumer 102 may lack the capacity to receive, store, or view electronic receipts. In any event, one of ordinary skill in the art will appreciate that there are instances where the consumer 102 initially receives a paper receipt from merchant 104 but later wishes to quickly and easily submit the information contained on that paper receipt to an e-receipts account managed by the financial institution computer system 120.

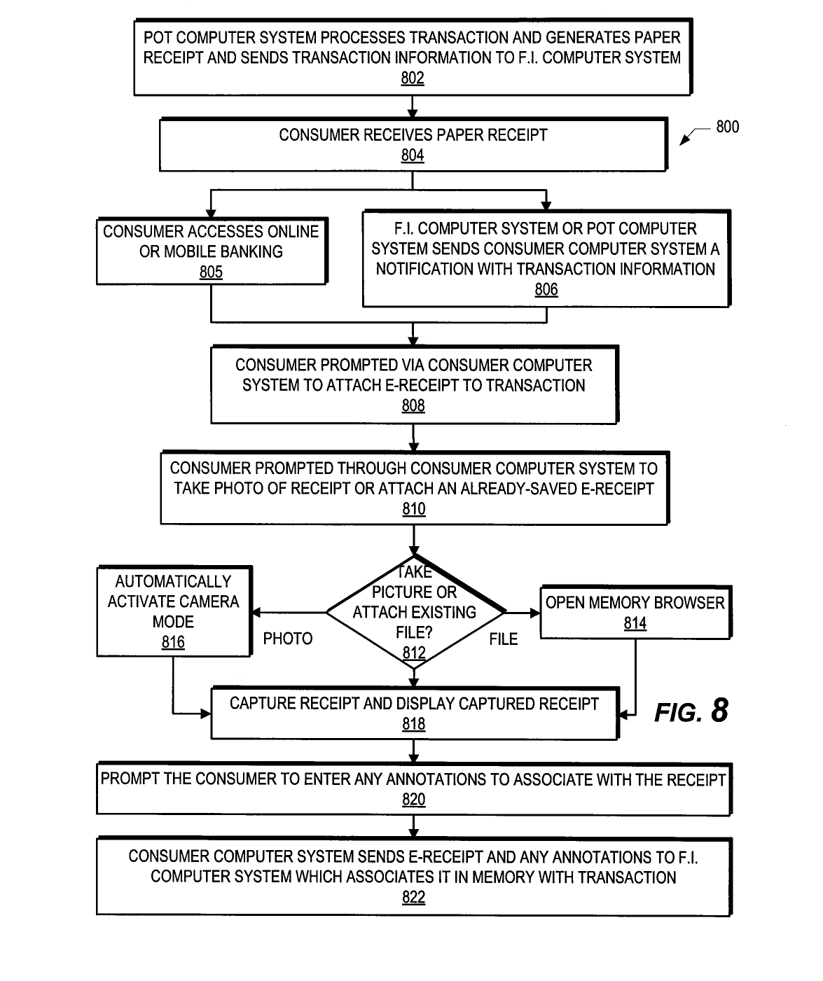

Accordingly, with reference now to FIG. 8, a flow chart illustrating a different method 800 of submitting electronic receipts in accordance with some embodiments of the invention is provided. In particular, FIG. 8 represents an exemplary method of submitting an electronic receipt to e-receipt application 127 when the consumer 102 receives a paper receipt from the merchant and the computer system 110 is the mobile device 200 or other electronic device with an integrated camera.

As represented by block 802 in FIG. 8, the consumer 102 first makes a purchase that gives rise to a paper receipt. As represented by block 804, the consumer 102 receives a paper receipt at the conclusion of a purchase. In some embodiments, the consumer 102 receives this paper receipt directly from merchant after the purchase has been concluded, and in other embodiments, the merchant mails the consumer 102 a copy of the paper receipt.

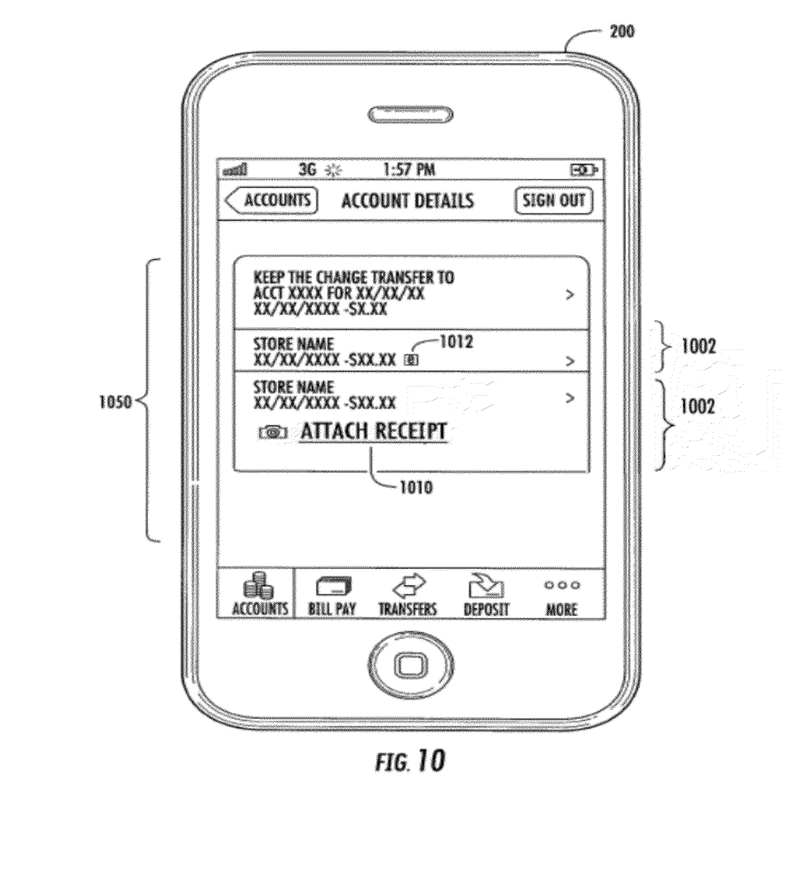

As represented by block 808, the consumer 102 is prompted via the consumer computer system 110 to attach an electronic receipt to the transaction. For example, in one embodiment of the invention, as represented by block 805, the consumer 102 uses the consumer computer system 110 to access a mobile banking platform (e.g., by executing a mobile banking application 221) or an online banking platform (e.g., by executing a web browser application 222 and using it to access an online banking website). FIG. 10 illustrates the user interface for an exemplary mobile banking application 221 displayed on the consumer's mobile device 200, in accordance with an embodiment of the invention. The interface displays a list 1050 of transactions relating to one or more of the consumer's financial accounts. The list 1050 includes certain transactions 1002, such as purchase transactions, that include an attach receipt link 1010 that prompts the user to attach an electronic receipt to the transaction 1010.

In other embodiments of the invention, as represented by block 806, the financial institution computer system 120 or the POT computer system 130 sends the consumer computer system 110 a transaction notification with transaction information. For example, a notification such as the one illustrated in FIG. 4 could be sent to the consumer computer system 102 via text message and have an “eReceipt” link or something similar that prompts the consumer 102 to attach an electronic receipt to the particular transaction described in the notification.

As represented by block 810, regardless of how the consumer 102 is prompted to attach an electronic receipt to a transaction, if the consumer 102 responds to the prompting by activating one of the links described above or other input mechanism, then the consumer 810 is, in one embodiment, provided with the option of either capturing an image of a paper receipt or attaching an already-saved electronic receipt stored in the mobile device's memory 113.

As represented by blocks 812 and 814, if the consumer 102 chooses to attach an already-saved electronic receipt, the mobile device 200 automatically launches a memory browser. The consumer 102 can then use the memory browser to locate the already-saved receipt from amongst the files stored in the memory device 113.

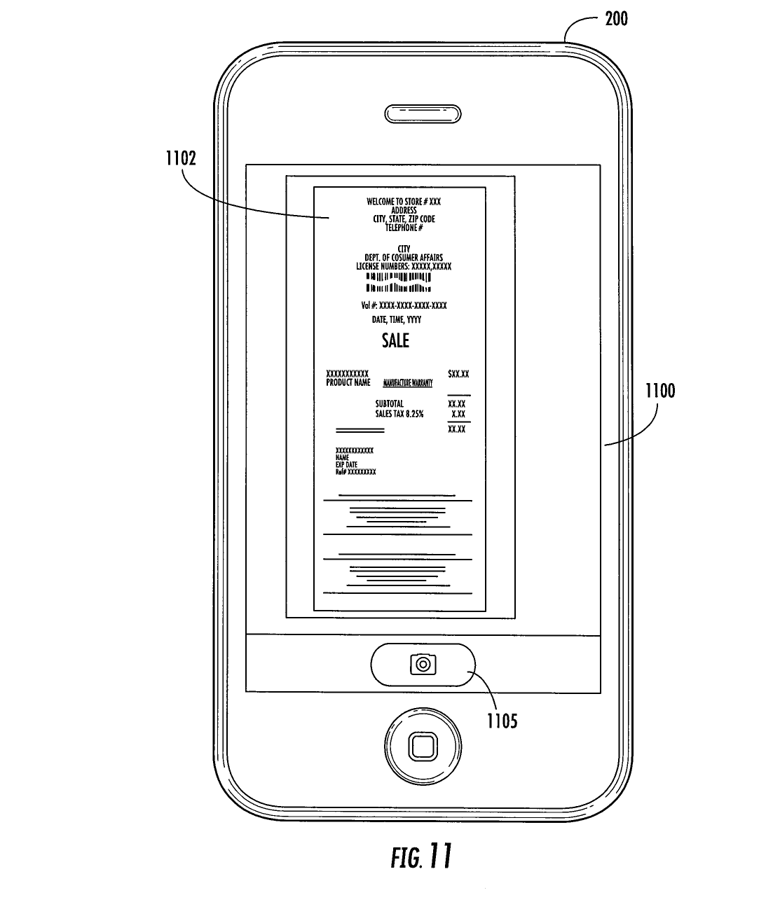

As represented by blocks 812 and 816, if the consumer 102 chooses to attach a photo of a not-yet-captured paper receipt, the mobile device 200 automatically switches to camera mode and launches a camera application 225. The camera application 225 causes the display 230 of the mobile device 200 to become the camera's viewfinder. For example, FIG. 11 illustrates the mobile device 200 in camera mode following the consumer 102 selecting to attach a photo of a paper receipt. As illustrated in FIG. 11, the consumer 102 aligns the mobile device 200 with the paper receipt 1102 so that the paper receipt 1102 is properly positioned in the viewfinder 1100. When the receipt is properly aligned with the camera, the consumer 102 uses button 1105 to instruct the mobile device to capture the image of the receipt 1102. The consumer 102 can then use the memory browser to locate the already-saved receipt from amongst the files stored in the memory device 113.

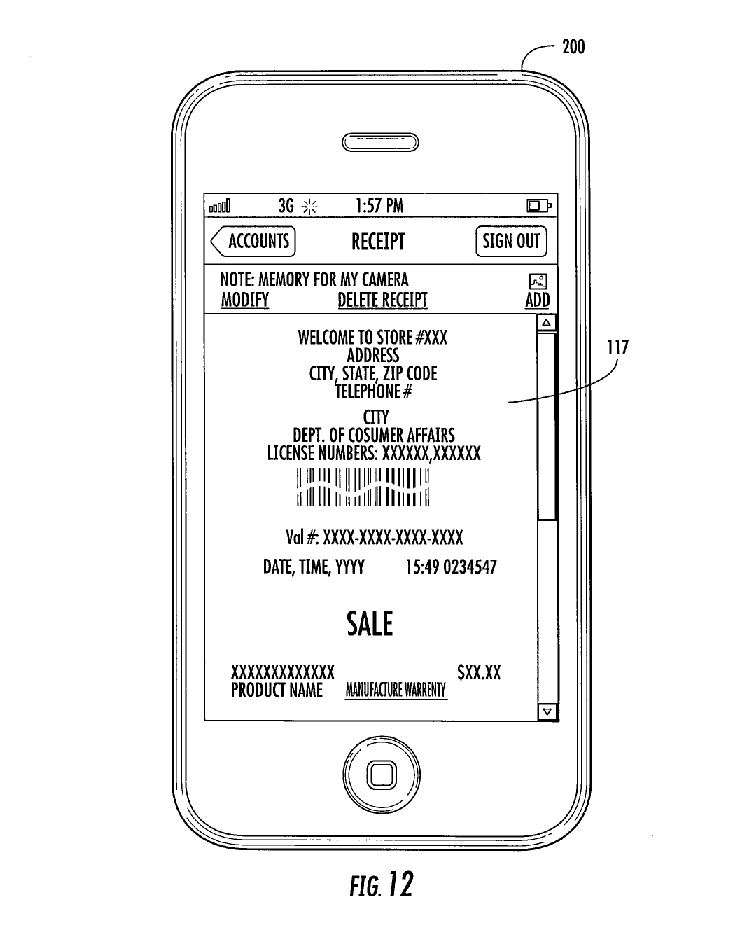

As represented by block 818, the captured or selected electronic receipt 117 is then displayed by the mobile device 200, for example, as illustrated in FIG. 12, so that the consumer 102 can review the receipt before submitting it to be stored at the financial institution computer system 120. As represented by block 820, in some embodiments of the invention, the interface includes an “add” link or some other input mechanism to associate an annotation with the electronic receipt.

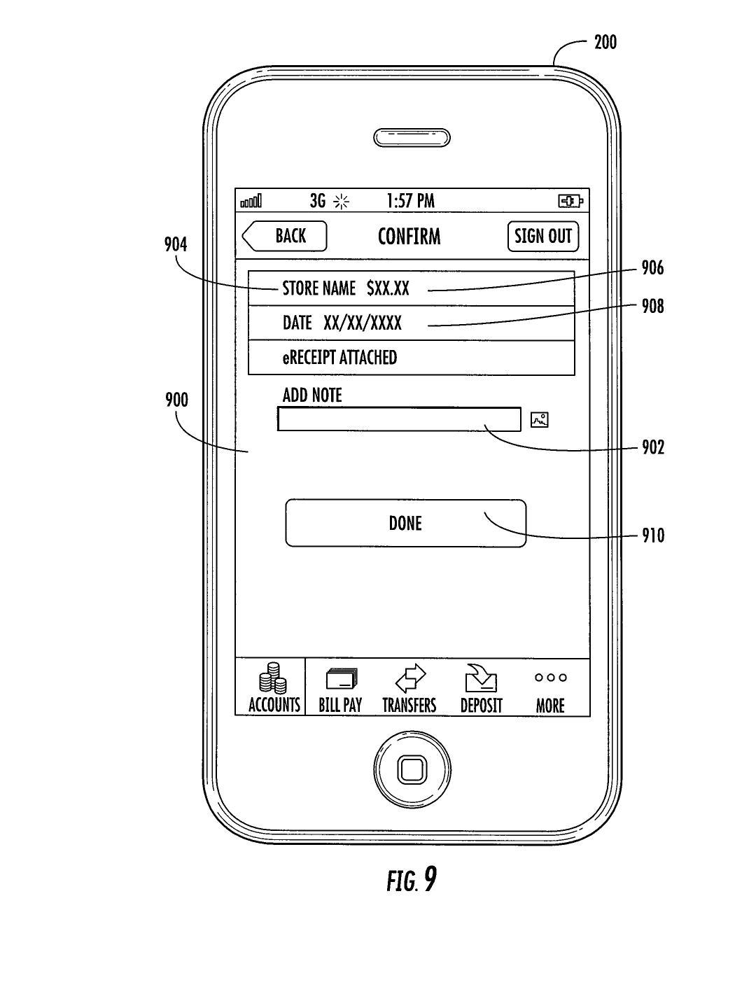

For example, the consumer 102 may want to add an annotation that provides additional information about the transaction and/or that may help the consumer 102 organize the electronic receipts. The consumer 102 may, for example, attach the word “tax” to the electronic receipt metadata to indicate that this is a receipt that may be associated with a tax deductible expenditure. In another example, the consumer 102 may want to take a picture of the product purchased and attach it to the electronic receipt file to help the consumer 102 know what the receipt pertains to at a later date. FIG. 9 illustrates an exemplary user interface that is displayed on the mobile device 200 to allow the consumer 102 to create annotations and associate them with a receipt or transaction. As illustrated in FIG. 9, the mobile banking application 221 provides the consumer 102 with a textual field 902 into which consumer 102 may enter textual notes or annotations through the use of a user input device 240. In some embodiments, the mobile banking application 221 also displays an image icon proximate to the textual field 902 that the user can select to switch the mobile device 200 into camera mode so that the consumer 102 can create a photo annotation. The mobile banking application 221 interface may also include some transaction information such as merchant information 904, amount information 906, and date information 908 for that transaction to which the consumer 102 intends to attach the annotation.

Referring again to FIG. 8 at block 822, once the consumer 102 has submitted an electronic receipt and any annotations into the mobile banking application 221, the mobile device 200 sends the electronic receipt and any annotations to the financial institution computer system 120 where it is stored in the system's memory device 123 and associated with the transaction.

After electronic receipts and/or annotations are submitted, the system also provides the consumer 102 with a way to review and manage electronic receipts that were previously submitted. For example, consumer 102 may want to review electronic receipts prior to submitting an expense report, filing income taxes, or meeting with an accountant. As one of skill in the art would appreciate, there are countless reasons why consumer 102 would want to view the electronic receipts that are stored in the consumer's e-receipts account.

One way through which the consumer 102 can view and/or modify already-submitted electronic receipts is through the use of a mobile banking application 221. Previously described FIG. 10 illustrates a mobile banking application interface that allows the consumer 102 to view a list of transactions associated with the consumer's account(s). Link 1012 shows that an electronic receipt has already been attached to a particular transaction. Selecting link 1012 pulls up an interface such as the one shown in FIG. 12, which allows the consumer 102 to view the already-submitted receipt and use the links to add to, modify, or delete the receipt and/or annotations.

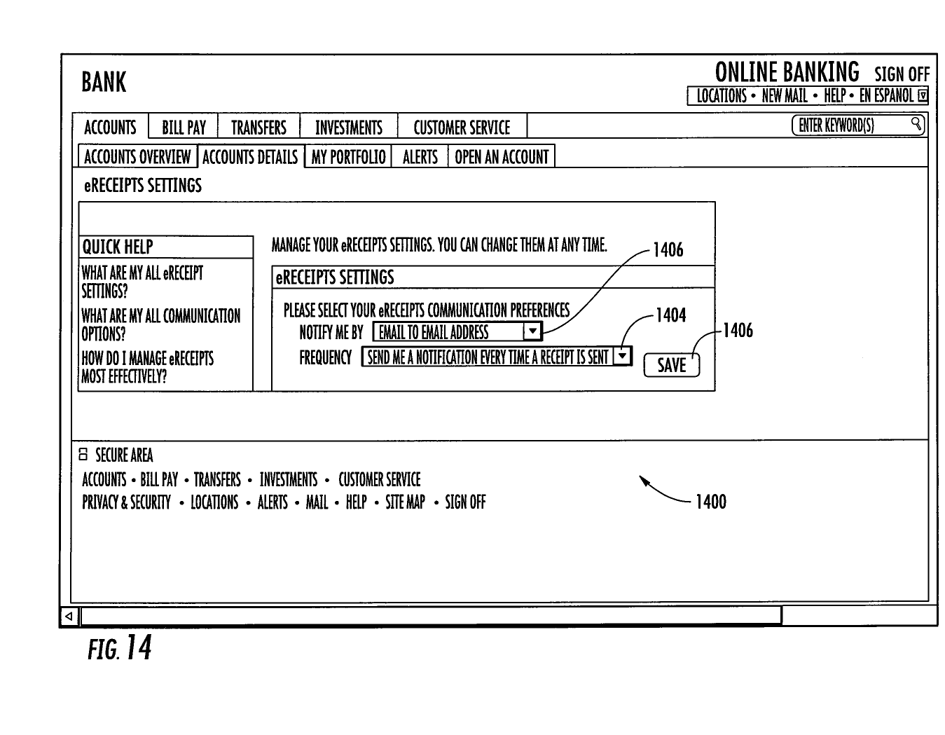

Another way through which the consumer 102 can view and/or modify already-submitted electronic receipts is through the use of an online banking platform. FIGS. 13A, 13B, 13C, and 14 illustrate different views and pages of an online banking platform that a consumer 102 can access via the Internet 166 and use to view and manage transaction information, electronic receipts, and annotations. As illustrated by FIG. 13A, after a consumer 102 logs into the online banking website 1300, the consumer 102 can select link 1301 to be transported to a web page, such as the one illustrated in FIG. 13B, that allows the consumer 102 manage the consumer's electronic receipts. In one embodiment of the invention, the web page provides a list 1350 of one or more e-receipt entries 1302, where each e-receipt entry 1302 is associated with an electronic receipt. Each e-receipt entry 1302 may contain information about a purchase, including, a date 1304, a merchant 1306, a category 1308, a payment type 1310, and an amount 1312. Each e-receipt entry 1302 may include a receipt icon 1314, which is a hyperlink that allows consumer 102 to display the electronic receipt associated with a receipt entry 1302 and assigned to a transaction. Alternatively, in other embodiments of the invention, any portion of e-receipt entry 1302 may be combined with receipt icon 1314. Any e-receipt entry 1302 that includes an annotation may include an annotation icon 1315, which is a hyperlink that allows consumer 102 to display the annotation associated with a receipt entry 1302 and assigned to a transaction. In some embodiments of the invention, the e-receipt entries 1302 are sortable by date 1304, merchant 1306, category 1308, payment type 1310, amount 1312, receipt icon 1314, and/or annotation icon 1315.

As seen in FIG. 13B, the web page may list the total 1314 of all electronic receipts stored in the e-receipts account. Additionally, the web page may also list the total amount 1316 of all electronic receipts stored in e-receipts account.

In some embodiments, the web page may also provide management hyperlinks 1318 that enable a consumer 102 to sort, submit, export, and import electronic receipts. New receipts hyperlink 1320 allows the consumer 102 to view all electronic receipts that have been submitted to the e-receipts account within a certain period of time. For example, in one embodiment, following the new receipts hyperlink 1320 would allow the consumer 102 to see only those electronic receipts that have been submitted within the last week. As one of ordinary skill in the art would appreciate, the time period associated with new receipts hyperlink 1320 could be set by consumer 102 or the financial institution.

As described in relation to an embodiment of block 310 of FIG. 3, upload hyperlink 1322 enables consumer 102 to submit any electronic receipt to the e-receipts account. Trash hyperlink 1324 allows the consumer 102 to see those e-receipt entries 1302 that the consumer 102 may have deleted from the list 1350 of e-receipt entries 1302. Export hyperlink 1326 allows the consumer 102 to export the information within list 1350 into an electronic format that may be readable by other computer programs, such as word processing programs, spreadsheet programs and the like. Import hyperlink 1328 allows the consumer 102 to import data or other information into list 1350, where that data or other information is readable by other computer programs, such as word processing programs, spreadsheet programs and the like. Statistics hyperlink 1330 enables consumer 102 to view statistics regarding the electronic receipts stored in e-receipt application 127, including but not limited to the amount purchased per receipt category 1308, the amount purchased per receipt retailer 1306 or the amount purchased per receipt payment type 1310.

FIG. 13C is a representation of the e-receipts account web page after the consumer 102 has followed receipt icon 1314 to review an electronic receipt associated with an e-receipt entry 1302 and assigned to a purchase. In one embodiment, the electronic receipt 1336 is displayed on top of the list 1350 of e-receipt entries 1302. Any notes and annotations 1334 that consumer 102 added before submitting the electronic receipt appear immediately above electronic receipt 1336. However, it should be appreciate that notes and annotations 1334 are not limited to being displayed above electronic receipt 1336. For instance, notes and annotations 1334 may appear below, to the side, or on top of electronic receipt 1336. Also, as seen in FIG. 13C, the e-receipts web page provides a close icon 1366, which enables the consumer 102 to close the display of the electronic receipt 1336. As also displayed in FIG. 13C, the e-receipts web page may provide hyperlinks to modify the annotations and notes 1334, delete the electronic receipt, or add additional annotations or notes 1334.

FIG. 14 is a representation of one embodiment of an online banking web page 1400 where the consumer 102 can control the e-receipt settings. In some embodiments, frequency setting 1404 may allow consumer 102 to provide a third party, such as a financial institution, with information regarding how often consumer 102 wishes to receive electronic receipts or transaction notification described above with respect to FIG. 3. For example, consumer 102 could indicate the preference to always receive electronic receipts and/or notifications or to only receive electronic receipts and/or notifications from purchases with certain merchants or above a certain amount. Notification setting 1406 allows consumer 102 to provide the financial institution or other third party with information regarding how electronic receipts should be transmitted to the consumer 102. The consumer 102 may provide a list of one or more email addresses, one or more telephone numbers, or a combination of one or more email addresses and telephone numbers. Accordingly and as previously disclosed in relation to blocks 304 and 306, in some embodiments, if consumer uses a payment method that is associated with a financial institution or other third party, then that third party may transmit an electronic receipt to consumer 102 in accordance with the settings of frequency setting 1404 and notification setting 1406.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

The foregoing embodiments have been described for the purposes of example only and do not limit the ways in which the submission, collection, organization or retrieval of electronic receipts may occur in accordance with the present invention. As used herein and in the claims, where it is said that a certain action is performed by a particular party, such a statement is intended to include situations where the certain action is performed by an agent of the particular party, unless the context of the statement clearly indicates otherwise. As used herein and in the claims, where it is said that a first party sends or receives something to or from a second party, such a statement is intended to include both situations where the first party sends or receives something directly to or from the second party and situations where the first party sends or receives something indirectly to or from the second party through on or more other intermediary parties.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method implemented by a computerized apparatus configured to manage a user's electronic receipts, the method comprising:
presenting the user with information about the user's bank account;
prompting the user to submit an electronic receipt to the computerized apparatus;
receiving an electronic receipt from the user; and
assigning the electronic receipt to a purchase relating to the user's bank account.

2. The method of claim 1 wherein the information about the user's bank account comprises a list of transactions.

3. The method of claim 1 wherein the information about the user's bank account comprises a list of electronic receipts.

4. The method of claim 1 wherein prompting the user to submit an electronic receipt comprises presenting the user with the option to attach an electronic receipt to information about a purchase.

5. The method of claim 1 wherein prompting the user to submit an electronic receipt comprises presenting the user with the option to upload an electronic receipt.

6. The method of claim 1 wherein prompting the user to submit an electronic receipt further comprises the step of prompting the user to take a photograph of a paper receipt.

7. The method of claim 6 wherein the computerized apparatus performs the method on a personal mobile electronic device.

8. The method of claim 1 wherein presenting the user with information about the user's bank account comprises providing the user with a notification that a merchant has generated an electronic receipt.

9. The method of claim 8 wherein the notification comprises the name of the merchant that generated the electronic receipt.

10. The method of claim 9 wherein the notification further comprises the amount of the electronic receipt, the date of the electronic receipt, and the transaction identification used by the merchant to identify the purchase from which the electronic receipt was generated.

11. The method of claim 1 wherein assigning the electronic receipt to a purchase comprises making a hyperlink to an electronic receipt available to a user via an online banking platform.

12. The method of claim 11 wherein the hyperlink to an electronic receipt is located near information describing the purchase to which the electronic receipt is assigned.

13. The method of claim 12, wherein the information describing the purchase includes the purchase date, purchase amount, and retailer.

14. The method of claim 1 wherein prompting the user to submit an electronic receipt further comprises the step of prompting the user to add notes or annotations that will be associated with the electronic receipt.

15. An apparatus comprising:
a communication device;
and a processing device communicably coupled to the communication device, wherein the processing device is configured to:
present the user with information about the user's bank account;
prompt the user to submit an electronic receipt to the apparatus; and
assign, in a memory device, the electronic receipt to a purchase relating to the user's bank account.

16. The apparatus of claim 15 wherein the information about the user's bank account comprises a list of transactions.

17. The apparatus of claim 15 wherein the information about the user's bank account comprises a list of electronic receipts.

18. The apparatus of claim 15 wherein to prompt the user to submit an electronic receipt comprises presenting the user with the option to attach an electronic receipt with information about a purchase.

19. The apparatus of claim 15 wherein to prompt the user to submit an electronic receipt comprises presenting the user with the option to upload an electronic receipt.

20. The apparatus of claim 15 wherein to prompt the user to submit an electronic receipt further comprises the step of prompting the user to take a photograph of a paper receipt.

21. The apparatus of claim 20 wherein the apparatus is a personal mobile electronic device.

22. The apparatus of claim 15 wherein to present the user with information about the user's bank account comprises providing the user with a notification that a merchant has generated an electronic receipt.

23. The apparatus of claim 22 wherein the notification comprises the name of the merchant that generated the electronic receipt.

24. The apparatus of claim 23 wherein the notification further comprises the amount of the electronic receipt, the date of the electronic receipt, and the transaction identification used by the merchant to identify the purchase from which the electronic receipt was generated.

25. The apparatus of claim 15 wherein to assign the electronic receipt with a purchase comprises making a hyperlink to an electronic receipt available to a user via an online banking platform.

26. The apparatus of claim 25 wherein the hyperlink to an electronic receipt is located near information describing the purchase with which the electronic receipt is assigned.

27. The apparatus of claim 26, wherein the information describing the purchase includes the purchase date, purchase amount, and retailer.

28. The apparatus of claim 15 wherein to prompt the user to submit an electronic receipt further comprises prompting the user to add notes or annotations that will be associated with the electronic receipt.

29. A computer program product for manage a user's electronic receipts, the computer program product comprising a computer-readable medium having computer readable program instructions stored therein, wherein said computer-readable program instructions comprise:
first instructions configured to present the user with information about the user's bank account;
second instructions configured to prompt the user to submit an electronic receipt; and
third instructions configured to assign the electronic receipt to a purchase relating to the user's bank account.

30. The computer program product of claim 29, wherein the information about the user's bank account comprises a list of transactions.

31. The computer program product of claim 29, wherein the information about the user's bank account comprises a list of electronic receipts.

32. The computer program product of claim 29, wherein to prompt the user to submit an electronic receipt comprises presenting the user with the option to attach an electronic receipt with information about a purchase.

33. The computer program product of claim 29, wherein to prompt the user to submit an electronic receipt comprises presenting the user with the option to upload an electronic receipt.

34. The computer program product of claim 29, wherein to prompt the user to submit an electronic receipt further comprises the step of prompting the user to take a photograph of a paper receipt.

35. The computer program product of claim 29, wherein to present the user with information about the user's bank account comprises providing the user with a notification that a merchant has generated an electronic receipt.

36. The computer program product of claim 35, wherein the notification comprises the name of the merchant that generated the electronic receipt.

37. The computer program product of claim 36, wherein the notification further comprises the amount of the electronic receipt, the date of the electronic receipt, and the transaction identification used by the merchant to identify the purchase from which the electronic receipt was generated.

38. The computer program product of claim 29, wherein to assign the electronic receipt with a purchase comprises making a hyperlink to an electronic receipt available to a user via an online banking platform.

39. The computer program product of claim 38, wherein the hyperlink to an electronic receipt is located near information describing the purchase with which the electronic receipt is assigned.

40. The computer program product of claim 39, wherein the information describing the purchase includes the purchase date, purchase amount, and retailer.

41. The computer program product of claim 29, wherein to prompt the user to submit an electronic receipt further comprises prompting the user to add notes or annotations that will be associated with the electronic receipt.

42. A method implemented by a computerized apparatus configured to manage a user's electronic receipts, the method comprising:
presenting the user with a list of transactions relating to the user's bank account;
prompting the user to attach an electronic receipt to one of the transactions;
prompting the user to generate an electronic receipt by taking a digital photograph of a paper receipt;
prompting the user to submit to the electronic receipt to a memory device; and
assigning, in the memory device, the electronic receipt to one of the transactions.

43. The method of claim 42, wherein one of the transactions is a purchase relating to the user's bank account.

44. The method of claim 42, wherein a personal mobile electronic device is used to take a digital photo of a paper receipt.

45. The method of claim 42, wherein the method is performed by a mobile application.

46. The method of claim 42, further comprising the step of prompting the user to confirm the transaction to which the electronic receipt is to be attached.

47. The method of claim 42, further comprising the step of prompting the user to add notes or annotations to be associated with the electronic receipt.

48. A method implemented by a computerized apparatus configured to manage a user's electronic receipts, the method comprising:
sending a notification to a user that an electronic receipt has been generated relating to a purchase between the user and a vendor;
prompting the user to view the electronic receipt;
presenting the user with a list of transactions relating to the user's bank account;
prompting the user to attach an electronic receipt to one of the transactions;
prompting the user to submit to the electronic receipt to a memory device; and
assigning, in the memory device, the electronic receipt to one of the transactions.

49. The method of claim 48, wherein the notification is sent to the user's personal mobile electronic device.

50. The method of claim 49, wherein the notification is sent using a SMS text messaging application.

51. The method of claim 49, wherein the notification is sent using a picture mail application.

52. The method of claim 49, wherein the notification comprises the name of the merchant that generated the electronic receipt.

53. The method of claim 49, wherein the notification further comprises the amount of the electronic receipt, the date of the electronic receipt, and the transaction identification used by the merchant to identify the purchase from which the electronic receipt was generated.

54. The method of claim 49, wherein the notification comprises a hyperlink to the electronic receipt.

55. An apparatus comprising:
a communication device; and
a processing device communicably coupled to the communication device, wherein the processing device is configured to:
store, in a memory device, information about the transactions of a user;
use the communication device to notify the user that an electronic receipt has been generated relating to a purchase between the user and a vendor;
use the communication to receive the electronic receipt from the user;
assign, in the memory device, the electronic receipt to the purchase between the user and the vendor.

56. The apparatus of claim 55, wherein the communication device notifies the user that an electronic receipt has been generated relating to a purchase between the user and a vendor by sending the user an email.

57. The apparatus of claim 55, wherein the communication device notifies the user that an electronic receipt has been generated relating to a purchase between the user and a vendor by sending the user a message to a personal mobile electronic device.

58. The apparatus of claim 55, wherein to assign the electronic receipt to the purchase comprises making a hyperlink to the electronic receipt available to the user via an online banking platform.
